(19) United States
(12) Patent Application Publication
(10) Pub. No.: US 2002/0032775 A1
(43) Pub. Date: Mar. 14, 2002

(54) System and method for transmitting and retrieving data via a distributed persistence framework

(76) Inventors: Ramesh Venkataramaiah, Irving, TX (US); Michael D. Harold, Shreveport, LA (US)

Correspondence Address: Raymond Van Dyke, Suite 300 South, 1001 Pennsylvania Avenue, N.W., Washington, DC, 20004, US

(21) Appl. No.: 09/939,610

(22) Filed: Aug. 28, 2001

Related U.S. Application Data
(60) Provisional application No. 60/228,597, filed on Aug. 28, 2000.

(30) Foreign Application Priority Data
Aug. 28, 2001 (WO) US01/26799

(51) Int. Cl. G06F 15/16; G06F 15/173

(52) U.S. Cl. 709/225; 709/203

(57) ABSTRACT

A method, system and apparatus allowing data processing among multiple physical locations using Lightweight Directory Access Protocol-enabled databases, effectively transforming multiple directory servers into a single logical database. The method, system and apparatus creates a dynamic, distributed database environment for processing complex data types, including data schemas, data documents and software objects. The distributed database environment is accessed either locally or remotely using a simple set of application programming interfaces, which include insert, update, delete and query capabilities. The persistence service supports commit and rollback protocols in a distributed transaction environment.

### CROSS REFERENCE TO PRIORITY APPLICATION

The present application claims priority on a provisional application, U.S. Ser. No. 60/228,597, entitled “Distributed Persistence Framework for e-Commerce and m-Commerce Java TM object models”, filed on Aug. 28, 2000, which is incorporated by reference herein.

### BACKGROUND OF THE INVENTION

1. Field of the Invention

The present invention relates generally to methods for electronically storing and retrieving data among multiple physical databases over a computer network using a distributed persistence service. In particular, the invention relates to a method and system in which data described as one or more data schemas, data documents and/or software objects may be transmitted from one computer environment to another through the use of a persistence service, which may be accessed either locally or remotely from any point in the network, and which in turn may store, update, delete and/or query the data in one or more databases, e.g., Lightweight Directory Access Protocol-enabled (LDAP) physical databases.

2. Description of Prior Art

Previous art related to X.500/LDAP has been applied to service delivery platforms, mobile communications systems, profile management, directory access mechanisms, instant messaging, security mechanisms providing access control and voice-over-IP controllers. The existing prior art, however, does not focus X.500/LDAP at a transaction level and address the persistence framework mechanism required for implementation of such a transaction. Exemplary samples of the known prior art include:

U.S. patent application No. 20010016880, entitled “Pluggable Service Delivery Platform,” by Cai, et. al., U.S. patent application No. 20010016492, entitled, “Mobile Communication Service Providing System and Mobile Service Providing Method,” by Igarashi et. al. and U.S. patent application No. 20010013029, entitled “Method of Constructing and Displaying an Entity Profile Constructed Utilizing Input from Entities Other than the Owner,” by Gilmore, U.S. patent application No. 20010011277, entitled “Network Directory Access Mechanism,” by Martin et. al., U.S. patent application No. 20010009017 entitled, “Declarative Message Addressing,” by Biliris et. al., U.S. patent application No. 20010007128, entitled “Security Mechanism Providing Access Control for Locally Held Data,” by Lambert et. al.

None of the above mentioned references, however, establish a methodology and/or system which supports storage and retrieval of complex data schemas, data documents and/or software objects, hereinafter referred to collectively as the “data,” in a network computing environment using multiple LDAP-enabled databases as a single distributed database. Additionally, none of the references allows the data to be accessed using a global, network-wide naming convention such as JAVA Naming and Directory Interface (JNDI), or to be both stored and retrieved using user-defined meta-data, or to be described as complex hierarchical data schemas, the elements of which may be stored in different LDAP-enabled databases. Finally, in the case of complex software objects including system level services such as messaging and workflow, and complex business objects, such as those related to order management and inventory management, none of the above references allow these complex software objects to be stored and retrieved in their binary form with the preservation of state.

Hierarchically structured directories have recently proliferated with the growth of the Internet, and a large number of commercial directory server implementations are now available. They are currently being used to store address books and contact information for people, enabling the deployment of a wide variety of network-resident applications such as corporate white pages and electronic messaging. The Internet Engineering Task Force (IETF) has recently standardized the popular Lightweight Directory Access Protocol (LDAPv3) for modeling and querying network-resident directory information, as well as accessing network directory services. An LDAP-based x.500 directory server can be viewed as a highly distributed database, in which the directory entries are organized into a hierarchical namespace and can be accessed using database style search functions. The LDAP query language for the current generation of management and browser applications providing read/write interactive access to LDAP directories is largely inadequate.

There is, therefore, a present need to provide an improved paradigm for storing and retrieving data in a network-based, directory-enabled, distributed database environment and for ensuring that the data can be added, updated and deleted without compromising its integrity.

It is, accordingly, an object of the present invention to set forth an improved paradigm for the storage and retrieval of complex data types within and across multiple LDAP-enabled databases in a globally-distributed network environment.

It is another object of the present invention to provide a method and system for the translation of multiple data types including data schemas, data documents and software objects into data types which can be stored in and retrieved from one or more LDAP-enabled databases using a single set of application programming interfaces.

It is a further object of the present invention to store and retrieve the data using meta-data definitions which are also stored in one or more LDAP-enabled databases.

In accordance with one aspect of the invention, it is a further object of the present invention to store and retrieve data without requiring traditional object-to-relational-mapping techniques, as is normally required with relational databases.

It is a still further object of the present invention to provide a method and system by which a persistence service can be accessed either locally or remotely from any point in the network.

In accordance with another aspect of the invention, it is a further aspect of the invention to uniquely identify data stored in one or more LDAP-enabled databases using a global naming convention such as JNDI.

It is a further object of the invention to store and retrieve software objects with their state in one or more LDAP-enable databases.

It is a another object of the invention to store complex software objects that may take the form of system level services, such as messaging and workflow, or that may take of complex business objects, such as order managers and inventory managers, in one or more LDAP-enabled databases.

In accordance with yet another aspect of the invention, it is a further object of the invention to store said complex software objects as a collection of software objects, each element of which may be stored in and retrieved from a different physical LDAP-enabled database.

In accordance with another aspect of the invention, it is a further object of the invention to allow the physical storage location of a software object to be changed at any time.

In accordance with a further aspect of the invention it is a further object of the invention to store and retrieve said complex objects using a collection of methods that include insert, update, delete and query capabilities.

Finally, and in accordance with an additional aspect of the invention, it is a further object of the invention to enable a unit of work in which all of the elements of a complex object take part in a commit/rollback protocol in which either all of the elements are changed as part of the unit of work or none of the elements are changed.

### SUMMARY OF THE INVENTION

The present invention discloses a method to bridge the gap between the directory query requirements of e-commerce applications and the limitations inherent in the LDAP query language.

In contrast to traditional database models and their related persistence mechanisms which require that data be stored at a single physical location, the present invention involves a method and system which allows data to be stored and retrieved in multiple physical locations using LDAP-enabled databases. This innovative advancement effectively transforms multiple directory servers into a single logical database. By its very nature, the method and system creates a dynamic, distributed database environment capable of storing and retrieving complex data types including data schemas, data documents and software objects. The system and method is a meta-level query construct that is composed of a sequence of efficient computable query languages, but retains the core LDAP philosophy of incurring low resource requirements.

Furthermore, this distributed database environment can be accessed either locally or remotely using a simple set of application programming interfaces which include insert, update, delete and query capabilities. This persistence service also supports commit and rollback protocols. As an example and not by way of limitation the present invention uses the storage and retrieval of system services and software objects associated with the processing of orders and the management of inventory in a distributed transaction environment.

### BRIEF DESCRIPTION OF THE DRAWINGS

The objects, features and advantages of the present invention are readily apparent from the detailed description of the preferred embodiments set forth below, in conjunction with the accompanying Drawings in which:

FIG. 1 is a diagram illustrating a distributed network utilizing the present invention; and

FIG. 2 is a block diagram illustrating the data storage and retrieval process of the present invention.

### DETAILED DESCRIPTION OF THE DRAWINGS

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

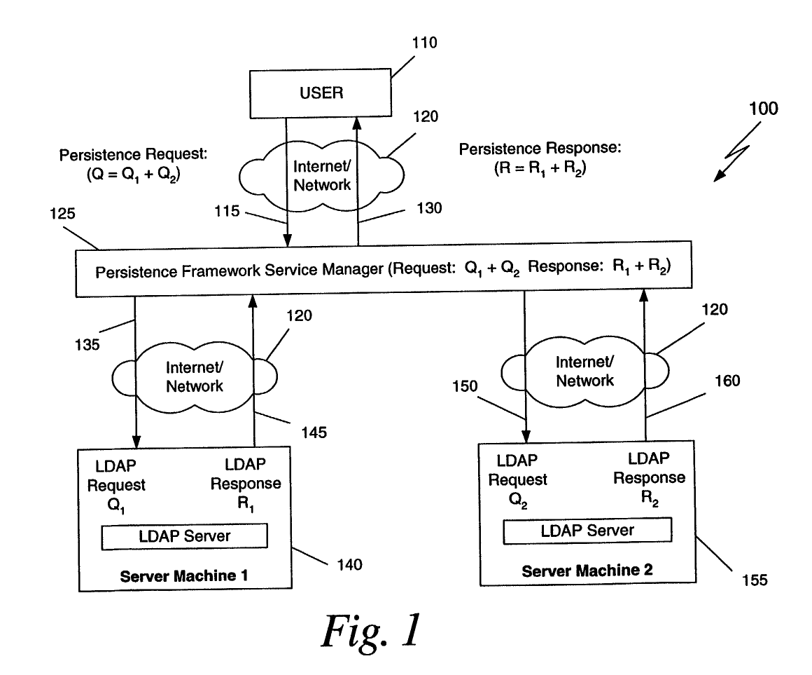

With reference now to FIG. 1 of the Drawings, there is illustrated therein a distributed communications network, generally designated by the reference numeral 100, utilizing the principles of the present invention. A user 110 of the network 100 can constitute any of a variety of devices, including a human, a computer, a cellular telephone, or a PDA device, as is understood in the art. As shown in the figure, the user 110 sends a request for persistence service, designated by the reference numeral 115, through an Internet or other network, generally designated by the reference numeral 120, to store, modify, update, query or retrieve data. As shown in FIG. 1, the persistence request 115 (Q) is composed of multiple pieces of data that are not stored in the same LDAP server, i.e., Q1 and Q2. The network 120 routes the request 115 to a Persistence Framework Service Manager 125. The Persistence Framework Service Manager 125 dissects the persistence request 115 (into Q1 and Q2) and collects the pieces of data (R1 and R2) from storage and returns a response 130 (R) to the user 110. For example, as shown in FIG. 1, the Persistence Framework Service Manager 125 transmits a Lightweight Directory Access Protocol (LDAP) request, designated by the reference numeral 135, to a first Server Machine 140 through the network 120. Server Machine 140 transmits an LDAP response 145 (with R1) back to the Persistence Framework Service Manager 125 again through network 120. Similarly, the Persistence Framework Service Manager 125 transmits another LDAP request 150 to a second Server Machine 155 for the remaining data, i.e., R2. Server Machine 155 then transmits an LDAP response 160 (with R2) to the Persistence Framework Service Manager 125. The Persistence Framework Service Manager 125 then transmits the requested data (R1 and R2) 130 back to the user 110 through the network 120.

With further reference to FIG. 1, the federated characteristics of the present invention are also illustrated. For example, the user 110 may wish to retrieve data from the network 120. The user 110 may successfully retrieve the data by transmitting a request to an appropriate directory server, which, as is well understood in the art, stores data in a hierarchal format. Thus, the server may point an incoming request to the appropriate location for retrieval whether it be on that server or another directory server altogether. Similarly, data storage for the present invention is conducted in the same fashion. For example, the user 110 may no longer be in need of data and wishes to store it. The user 110 then transmits the data to the Persistence Framework Service Manager 125, which correspondingly stores said data to the appropriate LDAP server or servers, e.g., servers 140 and 155 in FIG. 1.

Therefore, the federated and hierarchal characteristics of the persistence storage system and method allows the user of the network to effectively transform a plurality of directory servers into a single logical database. It is to be appreciated that while FIG. 1 only illustrates two physical databases, the present invention may utilize an unlimited number of physical databases in the application of the principles disclosed herein. Further, it is to be understand that while a request for persistence service has largely been described in terms of storing and retrieving data, a request for persistence service may include the following operations: storing, modifying, updating, querying or retrieving data.

It is to be appreciated that the present invention applies to a variety of data types including complex software objects that may take the form of system level services such as messaging and workflow or that may take the form of complex business objects such as order managers and inventory managers in one or more LDAP-enabled devices. In addition, the invention is capable of storing software objects as a collection of software objects, each element of which may be stored in and retrieved from a different physical LDAP-enabled device.

Further, it is to be appreciated that the present invention is compatible and makes use of commit and rollback protocols. Commit and rollback protocols are well known to those skilled in the art of transactions in a distributed networking environment. An online transaction that has multiple entries from a user may at a certain stage commit the user to the transaction or roll the transaction back to the first stage. By way of example, an on-line credit card transaction utilizes commit and rollback protocols.

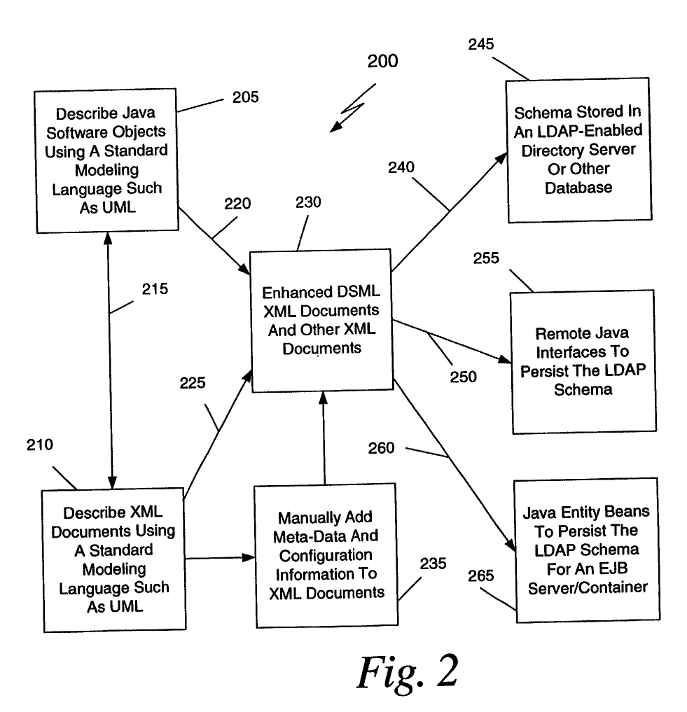

With reference now to FIG. 2, there is illustrated a block diagram that depicts a methodology, generally designated therein by reference numeral 200, for creating data schemas, data documents and software objects using the principles of the present invention. Data are initially described using a standard modeling language, such as the Universal Modeling Language or UML and enter the system defined as software objects in a language, such as Java, or as data documents defined as Extended Markup Language (XML), generally designated by the reference numerals 205 and 210 respectively. As shown in FIG. 2, data defined as software objects 205 may be translated (step 215) into data defined as data documents 210. Data defined as data documents 210 may conversely be translated 215 into data defined as software objects 205, as indicated by the bidirectionalness of the translation 215 arrows in FIG. 2.

Data are then submitted either directly as software objects (step 220) or as data documents (step 225) to an XML translation program 230 that converts both software objects 205 and data documents 210 into enhanced data documents that contain the data and attributes described in the original software objects 205 and data documents 210, respectively, as well as the additional information necessary to support the storage and retrieval of the data using the invention. Additional information that may be added by this program 230 includes, but is not limited to a Directory Server Markup Language (DSML) that supports the storage and retrieval of data in an LDAP-enabled Directory Server environment.

With reference again to FIG. 2, it is also possible to manually add meta-data and configuration information 235 to the aforementioned data documents 210 before they are submitted to the XML translation program 230. Configuration information that may be added to describe meta-data includes, but is not limited to, Extensible Stylesheet Language or XSL, XSLT (which is a language for translating XML documents into other XML documents), and XPath (which is a language designed to be used in combination with XSLT for addressing individual parts of an XML document).

Through the use of the global naming convention, Java Naming and Directory Interface (JNDI) and the assigned meta-data in 235, the present invention allows a user to store an object with its respective state and to retrieve the object with that state. As is understood in the art, the term “state” refers to various characteristics of the object. Once retrieved, the object is returned with that particular state, or with the same characteristics with which it was stored.

For example, if the user 110 in FIG. 1 transmits a request 115 to retrieve a data object, different parts of that object may be stored on different directory servers. One portion of the data object may be stored on a server in a Japan and the other may be stored in the United States. By use of the aforedescribed global naming convention, the Persistence Framework Service Manager 125 may seek the respective portions of the data object by retrieving the information from the respective servers before transmitting the request 130 back to the user 110.

Referring back now to the methodology illustrated in FIG. 2, upon leaving the translation program 230, the object may be, if necessary, serialized into a bit stream and stored as a binary large object (BLOB) or a large object (LOB). The form in which the data is stored or retrieved will depend on a variety of factors, including the requested form of the data and the size of the data that is requested, as understood in the art.

The XML translation program 230 outputs XML documents that in turn may be translated into any combination of schemas and/or interfaces that are then stored. One translation (step 240) results in data definition schemas 245 that may be stored directly into LDAP-enabled databases. The translation of XML and software object descriptions into data definition schemas 245 is the means whereby LDAP-enabled databases are able to store data associated with the schemas. These schemas identify the structure of the XML data definitions and software objects and describe in detail the names, data types and read/write permissions of the attributes contained within the XML and software object descriptions. Once the schema is loaded into the database, the database has the information it needs to add, update, delete and query instances of the data associated with a given schema.

With reference again to the methodology of FIG. 2, another translation (step 250) includes the generation of JNDI state factories, object factories and other program language code necessary to support those software program interfaces 255 in a language, such as Java, that may be used to persist the data originally described as software objects 205 and/or data definitions 210. The translation of XML and software object descriptions into persistence service interfaces 255 allows software applications to use the persistence service to add, update, delete and query data stored in LDAP-enabled databases without having to know about the number and location of specific physical instances of LDAP-enabled databases. As new XML and software object descriptions are created, new interfaces can be generated which store instances of the new data in LDAP-enabled databases along with existing data. When XML and software object descriptions are changed, new interfaces are generated. This allows multiple versions of XML and software object descriptions to be stored and accessed within the same LDAP-enabled database or databases. All interfaces are generated as Java programming language constructs and are able to be accessed by any system or method that provides support for the Java language.

Another translation (step 260) generates other standard interfaces 265 such as Java Entity Beans interfaces, that may be used in conjunction with Enterprise Java Beans (EJB) applications. The Java Bean and Enterprise Java Bean (i.e., EJB) specifications provide a standard developer interface for the creation of Java software objects. This interface allows developer-defined Java objects to interact very easily with other services in the Java environment. The translation 260 of XML and software object descriptions into Java Entity Bean interfaces 265 allows developers to easily access the persistence service from their Java Bean and Enterprise Java Bean applications.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

What is claimed:

1. In a distributed computer network, a method for processing data stored in multiple locations within said network, said network including at least one directory server and at least one persistence framework service manager, and said data including at least one of data schemas, data documents and software objects, said method comprising the steps of:
dissecting, by said at least one persistence framework service manager within said network, a request for a persistence service from a user, said request including at least two request portions therein;
transmitting, by said at least one persistence framework service manager, said at least two request portions to at least two respective directory servers within said network, said directory servers each respectively storing data therein;
receiving, by said persistence framework service manager, data from said at least two respective directory servers pursuant to said at least two request portions;
transmitting, by said persistence framework service manager, the data from said at least two respective directory servers.

2. The method according to claim 1, wherein said persistence service is selected from the group consisting of storing, retrieving, modifying, updating and querying said data.

3. The method according to claim 1, wherein said at least two directory servers each comprise a Lightweight Directory Access Protocol-enabled database.

4. The method according to claim 1, wherein said distributed network is the Internet.

5. The method according to claim 1, further comprising the step of uniquely identifying stored data by using a global, network-wide naming convention.

6. The method according to claim 1, further comprising the step of using user-defined meta-data to store and retrieve data on said at least two directory servers.

7. The method according to claim 1, further comprising the step of describing said data in a complex hierarchical schema, the elements of said complex hierarchical schema being stored on said at least two directory servers.

8. The method according to claim 1, further comprising the step of processing said data and respective states of said data in binary form.

9. The method according to claim 1, further comprising the step of processing software objects with their respective states in at least one Lightweight Directory Access Protocol-enabled database.

10. The method according to claim 1, wherein software objects within said directory servers comprise system level services or complex business objects.

11. The method according to claim 1, wherein software objects are stored within said at least two directory servers as a collection of software objects.

12. The method according to claim 1, wherein each element of said software objects is stored on respective directory servers.

13. The method according to claim 12, wherein said at least two directory servers are Lightweight Directory Access Protocol-enabled databases.

14. The method according to claim 12, wherein the physical storage location of the elements of a given software object on said at least two directory servers is subject to change.

15. The method according to claim 10, wherein all of the elements of a complex business object take part in a commit/rollback protocol in which either all of the elements are changed as part of the unit of work or none of the elements are changed.

16. In a distributed computer network, a system for processing data stored in multiple locations within said network, said network including at least one directory server and at least one persistence framework service manager, and said data including at least one of data schemas, data documents and software objects, said system comprising:
a user device for generating requests for a persistence service;
a persistence framework service manager for processing persistence service requests, a given persistence service request including at lease two request portions therein;
at least two directory servers, said at least two directory servers each respectively storing data therein, said at least two directory servers forwarding data to said persistence framework service manager pursuant to said at least two request portions; and
processor means for receiving said requests for said persistence service, accessing said data from said at least two directory servers and transmitting data to the user.

17. In a distributed computer network, a persistence framework service manager comprising:
dissecting means for dissecting a request for a persistence service from a user, said request including at least two request portions therein;
first transmitting means for transmitting said at least two request portions to at least two respective directory servers within said network, said directory servers each respectively storing data therein;
receiving means for receiving data from said at least two respective directory servers pursuant to said at least two request portions; and
second transmitting means for transmitting the data from said at least two respective directory servers.
